(19) United States
(12) Patent Application Publication
(10) Pub. No.: US 2021/0010481 A1
(43) Pub. Date: Jan. 14, 2021

(54) APPARATUS AND METHOD OF CONTROLLING AN AIR COMPRESSOR TO EXPEL MOISTURE FROM THE AIR COMPRESSOR

(71) Applicant: Bendix Commercial Vehicle Systems LLC, Elyria, OH (US)

(72) Inventors: William Plow, Avon Lake, OH (US); Majed Hamdan, North Olmsted, OH (US)

(21) Appl. No.: 16/504,744

(22) Filed: Jul. 8, 2019

(51) Int. Cl. F04D 27/02; B60T 17/00

(52) U.S. Cl. CPC F04D 27/0261; B60T 17/004

(57) ABSTRACT

An apparatus is provided for controlling a vehicle air compressor. The apparatus comprises an input for receiving a signal indicative of operation of the vehicle air compressor. The apparatus also comprises a data storage unit arranged to, when the vehicle is in a driving state, store signals from the input. The apparatus further comprises a processing unit arranged to, when the vehicle is in a non-driving state, control the vehicle air compressor to expel moisture from the vehicle air compressor based upon signals that have been stored over a period of time in the data storage unit.

### BACKGROUND

The present application relates to vehicle air charging systems, and is particularly directed to an apparatus and method of controlling an air compressor to expel moisture from the air compressor.

A typical vehicle air charging system includes an air compressor which builds air pressure for use in other vehicle air systems, such as a vehicle air braking system. System air pressure is controlled between a preset maximum and minimum pressure level by monitoring the air pressure in a supply reservoir. When the supply reservoir air pressure becomes greater than that of a preset “cut-out” setting, the compressor stops building air and also causes an air dryer downstream from the compressor to go into a purge mode. As the supply reservoir air pressure drops to a preset “cut-in” setting, the compressor returns back to building air and the air dryer to an air drying mode.

The air dryer is an in-line filtration system that removes water vapor from the compressor discharge air after it leaves the compressor. This results in cleaner, drier air being supplied to the vehicle air braking system, and aids in the prevention of air line and component freeze ups in winter weather. Removing water also prevents corrosion. The air dryer typically uses a replaceable cartridge containing a desiccant material. The air moves through the desiccant material which removes most of the water vapor.

Hybrid and all-electric vehicles commonly favor rotary compressors for their low vibration (noise, vibration and harshness) characteristics. An example rotary compressor is a screw type compressor. Another example rotary compressor is a rotary-vane type compressor. These compressors may use oil as a seal.

During operation of the compressor, it is important that water in the compressor be vaporized so that the vaporized water can be carried away in the compressor discharge air from the compressor. This prevents the water vapor from condensing and mixing with the oil in the compressor. If condensed water vapor were to be mixed with the compressor oil, the water would become trapped in the compressor oil. The trapped water could oxidize on surfaces of uncoated components of the compressor. This would lead then to degraded performance of the compressor components and/or degraded performance of overall compressor function. Accordingly, those skilled in the art continue with research and development efforts in the field of vehicle air charging systems.

### SUMMARY

In accordance with one embodiment, an apparatus is provided for controlling a vehicle air compressor. The apparatus comprises an input for receiving a signal indicative of operation of the vehicle air compressor. The apparatus also comprises a data storage unit arranged to, when the vehicle is in a driving state, store signals from the input. The apparatus further comprises a processing unit arranged to, when the vehicle is in a non-driving state, control the vehicle air compressor to expel moisture from the vehicle air compressor based upon signals that have been stored over a period of time in the data storage unit.

In accordance with another embodiment, an apparatus is provided for controlling a vehicle air compressor. The apparatus comprises means for operating the vehicle air compressor when the vehicle is in driving mode. The apparatus also comprises means for operating the vehicle air compressor when the vehicle is in compressor conditioning mode. The driving mode includes when the vehicle is in a driving or drivable state, and the compressor conditioning mode includes when the vehicle is in a state other than a driving or drivable state.

In accordance with yet another embodiment, an air compressor controller is provided for a vehicle air charging system having an air compressor. The air compressor controller comprises an input port for receiving compressor operating signals. The air compressor controller also comprises a data storage unit for storing a compressor control algorithm and compressor operating signals accumulated and logged over at least one period of time. The air compressor controller further comprises a processing unit for applying the compressor control algorithm to the logged compressor operating signals over the at least one period of time. The processing unit provides a compressor conditioning mode activating signal when the vehicle is parked. The air compressor controller also comprises an output port for communicating the compressor conditioning mode activating signal to activate the air compressor, thereby operating the air compressor to expel moisture from the air compressor based upon the logged compressor operating signals over the at least one period of time while the vehicle is parked.

In accordance with still another embodiment, a method is provided for a vehicle having an air compressor. The method comprises collecting operating data associated with the air compressor during driving mode of the vehicle. The method also comprises controlling operation of the air compressor during compressor conditioning mode of the vehicle based upon collected operating data associated with the air compressor to expel moisture from the air compressor.

### BRIEF DESCRIPTION OF THE DRAWINGS

FIG. 1 is a schematic diagram of an example vehicle air charging system including an air charging system controller constructed in accordance with an embodiment.

FIG. 2 is an example implementation of an air charging system controller which can be used in the vehicle air charging system of FIG. 1.

FIGS. 3A, 3B, and 3C show a flow diagram depicting an example method for a vehicle in accordance with an embodiment.

FIG. 4 is a flow diagram depicting an example method for a vehicle in accordance with another embodiment.

### DETAILED DESCRIPTION

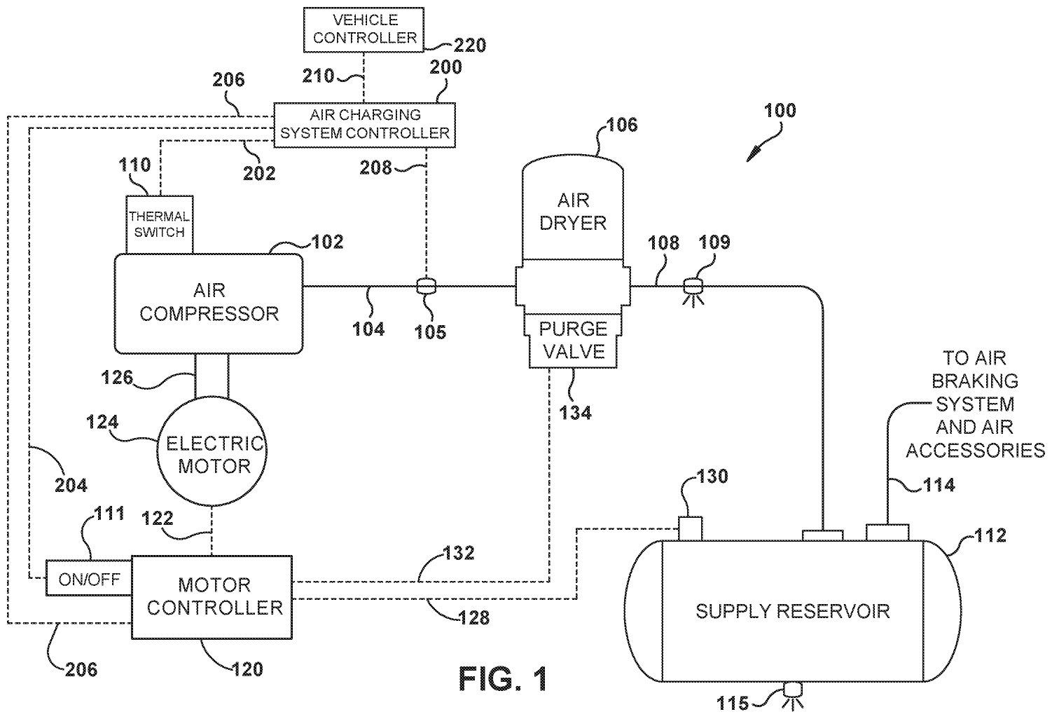

Referring to FIG. 1, a schematic diagram of a vehicle air charging system 100 including an example air charging system controller 200 constructed in accordance with an embodiment is illustrated. Vehicle air charging system 100 includes a rotating type of air compressor 102 that generates compressed air in conventional manner. Structure and operation of rotary air compressors are known and, therefore, will not be described. In FIG. 1, solid lines represent pneumatic lines between components, dashed lines represent electrical lines between components, and double-solid lines represent mechanical couplings between components.

A first discharge line 104 is pneumatically connected between the compressor 102 and an air dryer 106. A controllable exhaust port 105 is disposed in the first discharge line 104. A second discharge line 108 is pneumatically connected between the air dryer 106 and a supply reservoir 112. Although only one supply reservoir is shown, it is conceivable that a plurality of supply reservoirs be used. A controllable exhaust port 109 is disposed in the second discharge line 108. Air supply line 114 is pneumatically connected between the supply reservoir 112 and air braking system and air accessories (not shown) of the vehicle. The exhaust ports 105, 109 are external to the compressor 102, and can be operated either manually or automatically (e.g., electrically). A manual drain valve 115 is disposed on the supply reservoir 112. It is conceivable that the drain valve 115 may be replaced with a controllable exhaust port like the exhaust ports 105, 109. It is also conceivable that a controllable exhaust port be used in addition to the drain valve 115 on the supply reservoir 112.

A motor controller 120 controls on line 122 an associated electric motor 124 that is operatively coupled on line 126 to the compressor 102 to drive the compressor 102. The motor controller 120 communicates with the motor 124 to control the compressor 102 to maintain system air pressure between a preset maximum pressure level and a minimum preset pressure level by monitoring an electrical signal on line 128 from a pressure sensor 130 coupled to the supply reservoir 112. The signal on line 128 is indicative of air pressure in the supply reservoir 112.

When air pressure in the supply reservoir 112 becomes greater than that of a preset “cut-out” setting, the motor controller 120 controls the motor 124 to stop the compressor 102 from building air. The motor controller 120 also controls on line 132 a purge valve 134 to purge air from the air dryer 106 in a purge mode. When air pressure in the supply reservoir 112 drops to a preset “cut-in” setting, the motor controller 120 returns the compressor 102 back to building air and the air dryer 106 to an air drying mode.

The motor 124 is shown in FIG. 1 connected to and controlled by the motor controller 120. However, it is conceivable that the air charging system controller 200 be connected to communicate with the motor 124 or the motor controller 120, or both, to monitor the pressure on line 128 and to control the motor 124 and the purge valve 134. It is also conceivable that the motor controller 120 and the air charging system controller 200 may be combined as a single controller.

A thermal switch 110 is thermally coupled to the compressor 102. The selection of location for the thermal switch 110 depends on the known hottest location of the compressor 102, for example. More specifically, the thermal switch 110 is a temperature sensor that provides an electrical signal on line 202 to an input port of the air charging system controller 200, which electrical signal is indicative of the temperature of oil in the compressor 102. An ON/OFF control signal 111 is operatively coupled to the motor controller 120. The ON/OFF control signal 111 may comprise an input or output or communications link. For example, the ON/OFF control signal 111 may comprise a binary output sensor that provides an electrical signal on line 204 to an input port of the air charging system controller 200, which electrical signal is indicative of and correlates to the duty cycle of the compressor 102.

The air charging system controller 200 is responsive to the electrical signals on lines 202, 204 from the thermal switch 110 and the ON/OFF control signal 111 to provide an electrical signal at a bidirectional communications port on line 206 to control the compressor 102 via the motor controller 120 and an electrical signal at an output port on line 208 to control one of the exhaust ports 105, 109 (e.g., the exhaust port 105 as shown in FIG. 1) based upon a compressor control application program (i.e., a compressor control algorithm) as will be described herein. The line 206 is a communication link that supports bidirectional communication (e.g., variable speed requests, status, ON/OFF control signals, etc.) between the air charging system controller 200 and the motor controller 120. Optionally, the air charging system controller 200 is connected on electrical line 210 to communicate with a vehicle controller 220. The vehicle controller 220 is capable of providing the air charging system controller 200 with permissions to allow the air charging system controller 200 to carry out certain processes within the compressor control algorithm, as will also be described herein.

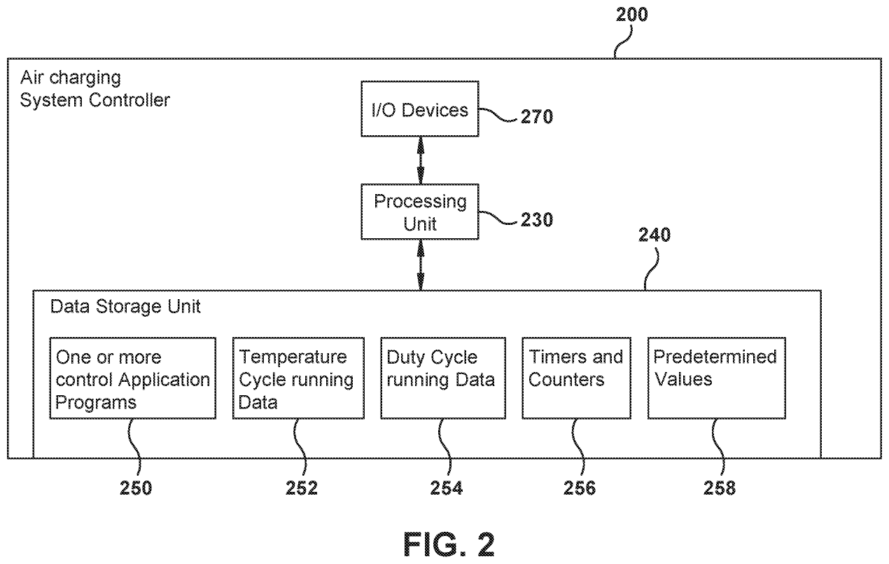

Referring to FIG. 2, an example implementation of the air charging system controller 200 of FIG. 1 is illustrated. The air charging system controller 200 includes a processing unit 230 that communicates with a data storage unit 240 and a number of input/output (I/O) devices 270. The processing unit 230 executes program instructions stored in the data storage unit 240, external data storage unit (not shown), or a combination thereof. The data storage unit 240 is configured to store one or more compressor control application programs 250, accumulated and logged temperature cycle running data portion 252 associated with operation of the compressor 102, accumulated and logged duty cycle running data portion 254 associated with operation of the compressor 102, various timers and counters portion 256, and various predetermined values portion 258. The data storage unit 240 is also configured to store other programs, data, etc. (not shown) as required.

The processing unit 230 may comprise any type of technology. For example, the processing unit 230 may comprise a dedicated-purpose electronic processor. Other types of processors and processing unit technologies are possible. The data storage unit 240 may comprise any type of technology. For example, data storage unit 240 may comprise random access memory (RAM), read only memory (ROM), solid state memory, or any combination thereof. Other types of memories and data storage unit technologies are possible.

The number of I/O devices 270 may comprise any type of technology. For example, I/O devices 270 may comprise a keypad, a keyboard, a touch-sensitive display screen, a liquid crystal display (LCD) screen, a microphone, a speaker, or any combination thereof. Other types of I/O devices and technologies are possible. The I/O devices 270 may or may not be integral to the air charging system controller 200.

In accordance with an aspect of the present disclosure, the air charging system controller 200 is responsive to a combination of sensor data associated with operation of the compressor 102. The sensor data is provided by, but is not limited to, the signal on line 202 from the thermal switch 110 and/or the signal on line 204 from the ON/OFF control signal 111. More specifically, the processing unit 230 executes instructions of one of the compressor control application programs 250 stored in the data storage unit 240 to expel moisture from the compressor 102, as will be described in more detail hereinbelow.

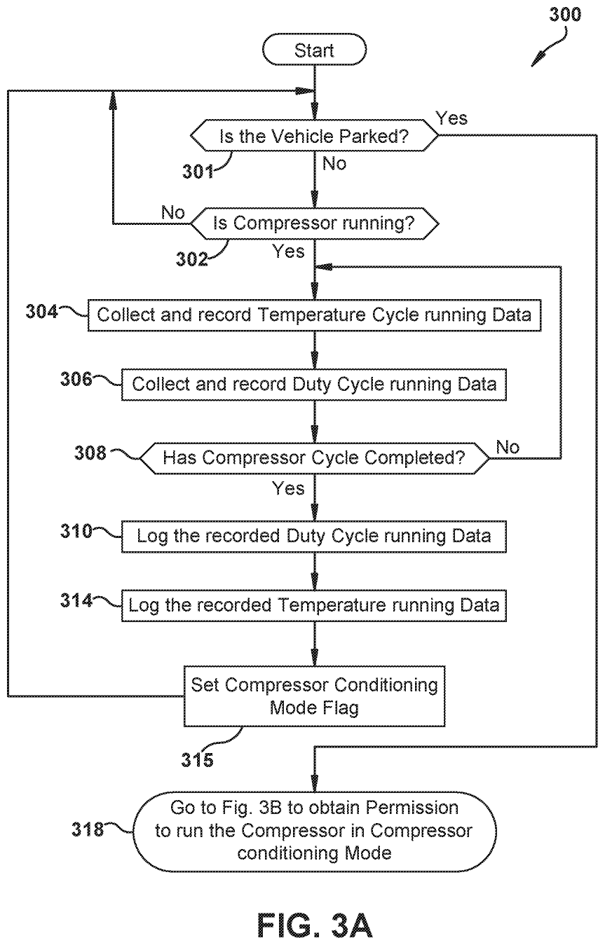

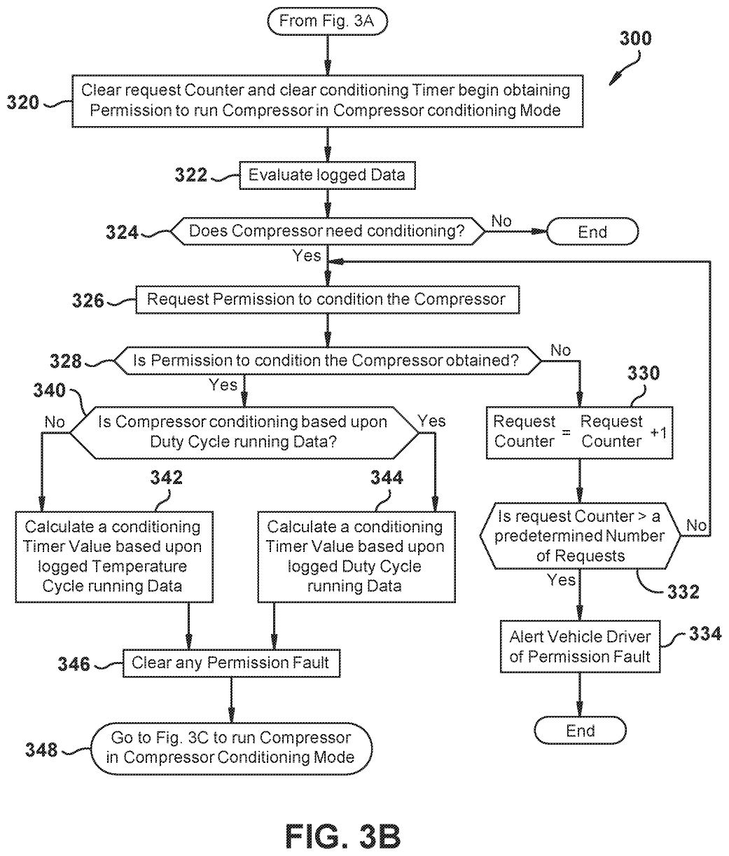

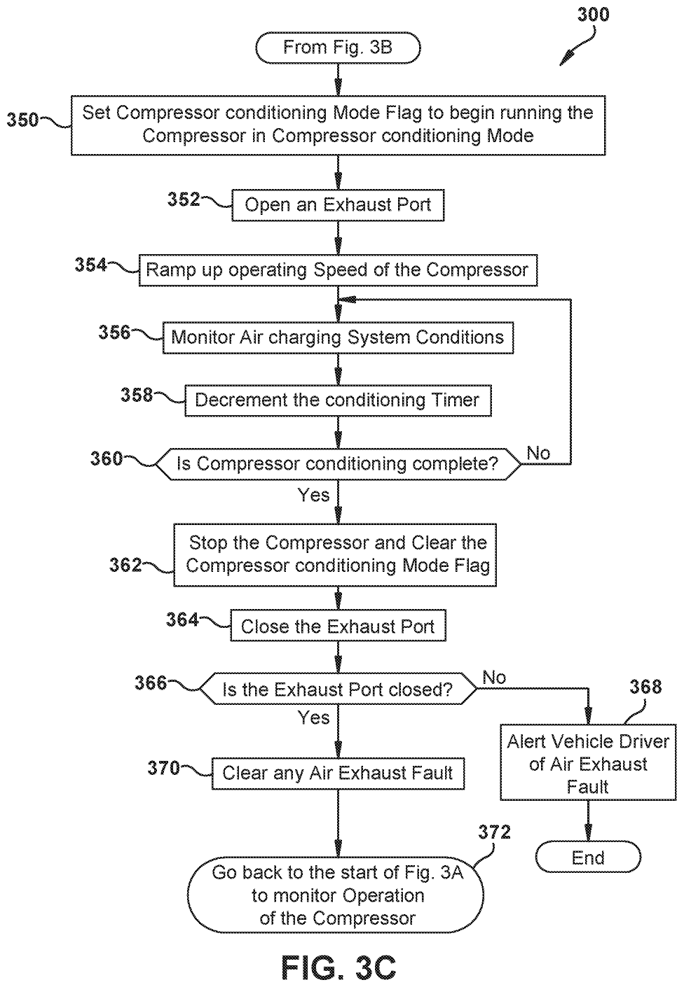

Referring to FIGS. 3A, 3B, and 3C, a flow diagram 300 depicts an example method for a vehicle in accordance with an embodiment. FIG. 3A is generally a portion of the flow diagram 300 depicting a process when the vehicle is in a driving mode. FIG. 3C is generally a portion of the flow diagram 300 depicting a process when the vehicle is in a compressor conditioning mode. FIG. 3B is generally a portion of the flow diagram 300 depicting a process in which certain vehicle conditions and/or compressor conditions need to be satisfied before the vehicle can transition from the driving mode of FIG. 3A to the compressor conditioning mode of FIG. 3C. The driving mode of the vehicle includes a driving state in which the vehicle is in motion and a drivable state in which the vehicle is permitted to be in motion. The compressor conditioning mode includes a non-driving state (e.g., when the vehicle is parked) which is other than the driving state or the drivable state.

In block 301 in FIG. 3A, a determination is made as to whether the vehicle is parked. The determination in block 301 may be made by another controller on the vehicle and transmitted to the air charging system controller 200. If the determination in block 301 is negative (i.e., the vehicle is not parked), the process proceeds to block 302. In block 302, a determination is made as to whether the compressor 102 is running. If the determination in block 302 is negative (i.e., the compressor 102 is not running), the process returns back to block 301 to continue monitoring the parking status of the vehicle. However, if the determination in block 302 is affirmative (i.e., the compressor 102 is running), the process proceeds to block 304. In block 304, temperature cycle running data associated with operation of the compressor 102 is collected and recorded in portion 252 of the data storage unit 240. Also, in block 306, duty cycle running data associated with operation of the compressor 102 is collected and recorded in portion 254 of the data storage unit 240. The process then proceeds to block 308.

In block 308, a determination is made as to whether a compressor cycle has completed. A completed compressor cycle is between when the compressor reaches the cut-in pressure and then reaches the cut-out pressure. If the determination in block 308 is negative (i.e., a compressor cycle has not been completed), the process returns back to block 304 to continue collecting and recording temperature cycle running data (in block 304) and collecting and recording duty cycle running data (in block 306). When the determination in block 308 is affirmative (i.e., a compressor cycle has been completed), the process proceeds to block 310 in which recorded duty cycle running data from block 306 is accumulated (i.e., totaled over at least one period of time) and logged in portion 254 of the data storage unit 240 before proceeding to block 314.

In block 314, recorded temperature cycle running data from block 304 is accumulated and logged in portion 252 of the data storage unit 240. An example way of accumulating the recorded temperature cycle running data is to use a temperature accumulator employing incremental values and decremental values. Accumulators which use increment values and decrement values are known. The temperature accumulator would increment a counter in the accumulator when the compressor oil temperature is below a predetermined threshold temperature value, and would decrement the counter when the compressor oil temperature is above the predetermined threshold temperature value.

The temperature accumulator can be configured such that the minimum value of the counter in the accumulator is about zero. The increment value and the decrement value may be the same or different from each other. The increment value, the decrement value, as well as the predetermined threshold temperature value, can be configured and stored in the data storage unit 240 for the particular compressor and its application. Alternatively, the increment value, the decrement value, as well as the predetermined threshold temperature value, can be automatically derived based on monitored conditions during operation of the compressor 102.

Then in block 315, a compressor conditioning mode flag is set before returning back to block 301 to continue monitoring the parking status of the vehicle. However, if the determination in block 301 is affirmative (i.e., the vehicle is parked), the process proceeds to block 318 to proceed to FIG. 3B to obtain permission to run the compressor 102 in compressor conditioning mode.

In block 320 in FIG. 3B, a request counter and a conditioning timer in portion 256 of the data storage unit 240 are cleared (i.e., set to a zero value) to begin the process of obtaining permission to run the compressor 102 in compressor conditioning mode. Then in block 322, the logged duty cycle running data from block 310 and the logged temperature cycle running data from block 314 in FIG. 3A are evaluated. The evaluation in block 322 is based upon the accumulated history of the temperature cycle running data stored in portion 252 of the data storage unit 240 and the accumulated history of the duty cycle running data stored in portion 254 of the data storage unit 240.

A determination is then made in block 324 as to whether the compressor 102 needs conditioning based upon the logged data that has been evaluated in block 322. If the determination in block 324 is negative (i.e., the compressor 102 does not need conditioning), the process ends. However, if the determination in block 324 is affirmative (i.e., the compressor 102 needs conditioning based upon evaluation of the logged data), the process proceeds to block 326.

As an example, an evaluation scenario in which the compressor 102 needs conditioning is when the history of the temperature cycle running data shows a value greater than zero in the temperature accumulator. As another example, an evaluation scenario in which the compressor 102 needs conditioning is when the history of the duty cycle running data shows a duty cycle lower than allowable for the particular compressor architecture (e.g., an allowable duty cycle of four percent).

As yet another example, an evaluation scenario in which the compressor 102 does not need conditioning is when the temperature cycle running data shows a temperature value that is greater than a predetermined minimum temperature value (for a certain temperature dwell time) and the duty cycle running data shows a duty cycle percentage that is greater than a predetermined minimum percentage value. The compressor 102 is not in compressor conditioning mode based upon both a first criterion associated with the temperature cycle running data and a second criterion associated with the duty cycle running data being met. The first criterion comprises when the temperature cycle running data shows a temperature value that is greater than a predetermined minimum temperature value, and the second criterion comprises when the duty cycle running data shows a duty cycle percentage that is greater than a predetermined minimum percentage value. If either one of these criteria is not met, then the compressor 102 does need conditioning. Both the temperature cycle running data and the duty cycle running data are required and used in this example.

In block 326, a request is made to obtain permission to condition the compressor 102 before proceeding to block 328. In block 328, a determination is made as to whether permission to condition the compressor 102 has been obtained. If the determination in block is negative (i.e., permission has not been obtained), the process proceeds to block 330 in which the request counter is incremented. If the incremented request counter does not exceed a predetermined number of requests, as determined in block 332, the process proceeds back to block 326 to continue making a request to obtain permission to condition the compressor 102. However, if the incremented request counter does exceed the predetermined number of requests, as determined in block 332, the process proceeds to block 334 to alert the vehicle driver of a permission fault before the process ends.

However, if the determination back in block 328 is affirmative (i.e., permission is obtained to condition the compressor 102), the process proceeds to block 340. In block 340, a determination is made as to whether conditioning of the compressor 102 is to be based upon duty cycle running data. If the determination in block 340 is negative (i.e., compressor conditioning is not to be based on duty cycle running data), the process proceeds to block 342. In block 342, a conditioning timer value is calculated based upon the logged temperature cycle running data and stored in the conditioning timer in the portion 252 of the data storage unit 240 before proceeding to block 346.

However, if the determination in block 340 is affirmative (i.e., compressor conditioning is to be based upon duty cycle running data), the process proceeds to block 344. In block 344, a conditioning timer value is calculated based upon the logged duty cycle running data and stored in the conditioning timer in portion 254 of the data storage unit 240 before proceeding to block 346. In block 346, any permission fault is cleared. Then in block 348, the process proceeds to FIG. 3C to run the compressor 102 in the compressor conditioning mode.

In block 350 in FIG. 3C, the compressor conditioning mode flag is set to begin running the compressor 102 in the compressor conditioning mode. The setting of the compressor conditioning mode flag acts as a compressor conditioning mode activating signal. As shown in block 352, one of the exhaust ports 105, 109 (FIG. 1) is opened in response to the compressor conditioning mode activating signal. The process proceeds to block 354 in which the compressor 102 is turned on and the operating speed of the compressor 102 is ramped up. The operating speed may be ramped to normal operating speed, above normal operating speed (e.g., 125% of normal operating speed), or below normal operating speed (e.g., 75% of normal operating speed), as desired or depending upon the specific compressor application. The process then proceeds to block 356.

In block 356, conditions of the vehicle air charging system 100 are monitored while the conditioning timer is decremented as shown in block 358. An example time value in the conditioning timer is three to ten minutes. Then, a determination is made in block 360 as to whether conditioning of the compressor 102 has been completed. If the determination in block 360 is negative (i.e., compressor conditioning has not yet been completed), the process returns back to block 356 to continue monitoring conditions of the vehicle air charging system 100 and to continue decrementing the conditioning timer in block 358.

However, if the determination in block 360 is affirmative (i.e., compressor conditioning has been completed), the process proceeds to block 362 in which the compressor 102 is stopped and the compressor conditioning mode flag is cleared before proceeding to block 364. In block 364, the exhaust port that was opened back in block 352 is closed. Then in block 366, a determination is made as to whether the exhaust port is closed. If the determination in block 366 is negative (i.e., the exhaust port is not closed), the process proceeds to block 368 to provide a signal to alert the vehicle driver of an air exhaust fault before the process ends. However, if the determination in block 366 is affirmative (i.e., the exhaust port is closed), the process proceeds to block 370 to clear any air exhaust fault before proceeding to block 372 to return back to the start of FIG. 3A to monitor operation of the compressor 102.

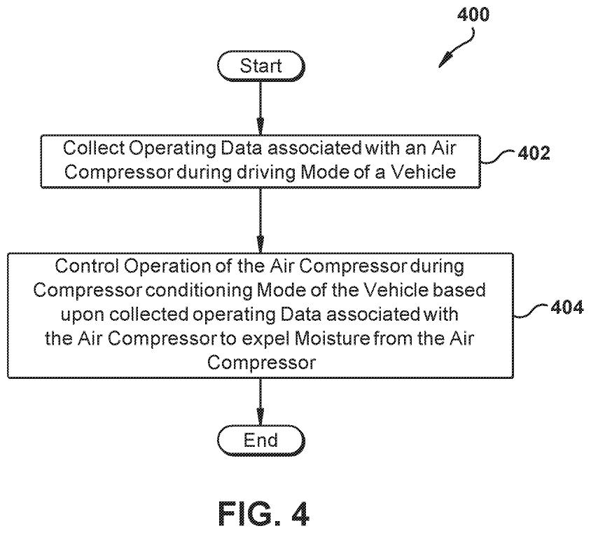

Referring to FIG. 4, a flow diagram 400 depicts an example method for a vehicle in accordance with another embodiment. In block 402, operating data associated with the air compressor is collected during driving mode of the vehicle. Then in block 404, operation of the air compressor is controlled during compressor conditioning mode of the vehicle based upon collected operating data associated with the air compressor to expel moisture from the air compressor.

In some embodiments, temperature cycle running data associated with the air compressor is collected during driving mode of the vehicle.

In some embodiments, duty cycle running data associated with the air compressor is collected during driving mode of the vehicle.

In some embodiments, both temperature cycle running data and duty cycle running data associated with the air compressor are collected during driving mode of the vehicle. In some embodiments, the method further comprises not running the compressor in compressor conditioning mode based upon both a first criterion associated with the temperature cycle running data and a second criterion associated with the duty cycle running data being met. The first criterion comprises when the temperature cycle running data shows a temperature value that is greater than a predetermined minimum temperature value, and the second criterion comprises when the duty cycle running data shows a duty cycle percentage that is greater than a predetermined minimum percentage value.

In some embodiments, operation of the air compressor is controlled during compressor conditioning mode of the vehicle based upon collected running data associated with the air compressor to vaporize water from compressor oil in the air compressor to allow the vaporized water to be directed away from the air compressor. In some embodiments, the vaporized water is directed through an exhaust port external to the air compressor to expel the water from the air compressor.

In some embodiments, operation of the air compressor is controlled while the vehicle is parked during compressor conditioning mode of the vehicle based upon collected operating data associated with the air compressor to expel moisture from the air compressor.

In some embodiments, the method is performed by a computer having a memory executing one or more programs of instructions which are tangibly embodied in a program storage medium readable by the computer.

The compressor control algorithm stored as one of the control application programs 250 in the data storage unit 240 allows the compressor 102 to operate efficiently during normal vehicle use where some water may be captured in the compressor 102, and then to expel the water at a more convenient later time during a natural recharge of the vehicle battery when efficiency is not as important. Compressor efficiency is especially important for an electric vehicle (whether all-electric or a hybrid) during normal vehicle use. For an electric vehicle, the compressor 102 is run in compressor conditioning mode while the vehicle is parked (e.g., not in a driving or drivable state) and may or may not be in a state of recharging the electric vehicle battery (i.e., the propulsion energy storage system of the vehicle). During an electric vehicle battery recharge cycle, the vehicle is parked which is a convenient time to condition the compressor 102.

The vehicle air charging system 100 finds particular application in conjunction with a heavy electric vehicle that uses regenerative braking. The use of regenerative braking in these vehicle applications reduces the amount of compressed air needed from the compressor 102. The reduced compressed air demand from the compressor 102 may result in unacceptable amounts of water being trapped in the compressor oil since the compressor 102 may not run long enough to sufficiently heat up the water to vaporize it so that the water vapor can be carried away with the compressor discharge air from the compressor 102. However, by providing the compressor conditioning mode disclosed herein, the compressor 102 is able to heat up and vaporize water in the compressor 102 while the vehicle is in a non-driving state so that the water does not become trapped in the compressor oil.

Although the above description describes a compressor conditioning mode in which permission is required to be obtained, it is conceivable that no permission need be obtained before the compressor 102 can be operated in the compressor conditioning mode. It is also conceivable that only temperature cycle running data be collected and recorded or that only duty cycle running data be collected and recorded.

Although the above description describes water in the compressor 102 being heated up and vaporized in the compressor conditioning mode while the vehicle is parked, it is conceivable that the water be heated up and vaporized in the compressor conditioning mode while the vehicle is in a non-driving state which is other than being parked. For example, the vehicle may be in a vehicle testing area off of public roads, which is a non-driving state other than being parked.

Also, although the above description describes the air charging system controller 230 initializing and terminating the compressor conditioning mode, it is conceivable that an operator actuates inputs to initiate and/or terminate the compressor conditioning mode with feedback from the components of the vehicle air charging system 100. It is also conceivable that an operator actuates inputs to initiate and/or terminate the compressor conditioning mode without feedback from the components of the vehicle air charging system 100.

Although the above description describes the compressor 102 as being a rotating type of compressor, it is conceivable that any type of compressor (including non-rotating compressors) that uses oil as a seal may be used.

Further, although the above description describes the vehicle air charging system 100 including the components shown in FIG. 1, it is conceivable that vehicle air charging system 100 need not include all of the components shown to condition the compressor 102 in the compressor conditioning mode. Moreover, it is conceivable that another controller be used to implement the conditioning mode. For example, the motor controller 120 or the vehicle controller 220 shown in FIG. 1 may be used to implement the compressor conditioning mode described herein. Any controller on the vehicle (e.g., brake, dash, etc.) may be used.

Also, although the above-description describes the vehicle air charging system 100 being used in conjunction with subsystems in an all-electric or hybrid vehicle, such as a heavy electric vehicle, it is conceivable that the vehicle air charging system 100 may be used in other types of heavy vehicles, such as busses for example.

The above-described example methods may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. An apparatus for controlling a vehicle air compressor, the apparatus comprising:
an input for receiving a signal indicative of operation of the vehicle air compressor;
a data storage unit arranged to, when the vehicle is in a driving state, store the signals from the input; and
a processing unit arranged to, when the vehicle is in a non-driving state, control the vehicle air compressor to expel moisture from the vehicle air compressor based upon signals that have been stored over a period of time in the data storage unit.

2. The apparatus according to claim 1, wherein the input includes a temperature sensor that provides signals indicative of temperature cycle of operation of the vehicle air compressor.

3. The apparatus according to claim 2, wherein the temperature cycle of operation of the vehicle air compressor is indicative of and correlates to temperature of compressor oil in the vehicle air compressor.

4. The apparatus according to claim 1, wherein the input includes a binary output sensor that provides signals indicative of duty cycle of operation of the vehicle air compressor.

5. The apparatus according to claim 1, wherein the processing unit is arranged to turn on the vehicle air compressor to run the vehicle air compressor when the vehicle is in the non-driving state so that water in compressor oil in the vehicle air compressor can be heated and vaporized to expel moisture from the vehicle air compressor.

6. The apparatus according to claim 1, wherein (i) a driving state of the vehicle includes when the vehicle is in motion or permitted to be in motion, and (ii) a non-driving state of the vehicle includes when the vehicle is parked.

7. The apparatus according to claim 1, wherein (i) an air charging system controller comprises the processing unit and the data storage unit, and (ii) the air charging controller is electrically connectable to a vehicle controller for communication with the vehicle controller.

8. An apparatus for controlling a vehicle air compressor, the apparatus comprising:
means for operating the vehicle air compressor when the vehicle is in driving mode; and
means for operating the vehicle air compressor when the vehicle is in compressor conditioning mode, wherein (i) the driving mode includes when the vehicle is in a driving or drivable state, and (ii) the compressor conditioning mode includes when the vehicle is in a state other than a driving or drivable state.

9. The apparatus according to claim 8, wherein a combination of an air compressor controller and a vehicle controller comprises both means.

10. The apparatus according to claim 8, wherein (i) the driving mode includes a driving state in which the vehicle is in motion and a drivable state in which the vehicle is permitted to be in motion, and (ii) the compressor conditioning mode includes a non-driving state in which the vehicle is parked.

11. An air compressor controller for a vehicle air charging system having an air compressor, the air compressor controller comprising:
an input port for receiving compressor operating signals;
a data storage unit for storing a compressor control algorithm and compressor operating signals accumulated and logged over at least one period of time;
a processing unit for applying the compressor control algorithm to the logged compressor operating signals over the at least one period of time, wherein the processing unit provides a compressor conditioning mode activating signal when the vehicle is parked; and
an output port for communicating the compressor conditioning mode activating signal to activate the air compressor, thereby operating the air compressor to expel moisture from the air compressor based upon the logged compressor operating signals over the at least one period of time while the vehicle is parked.

12. The air compressor controller according to claim 11, wherein the compressor conditioning mode activating signal is provided when the vehicle is parked and permission is granted based upon an approval signal being received from a vehicle controller.

13. The air compressor controller according to claim 11, wherein the compressor conditioning mode activating signal is provided when the vehicle is parked and permission is granted based upon approved conditions associated with operation of the vehicle air charging system being received from components of the vehicle air charging system.

14. A method for a vehicle having an air compressor, the method comprising:
collecting operating data associated with the air compressor during driving mode of the vehicle; and
controlling operation of the air compressor during compressor conditioning mode of the vehicle based upon collected operating data associated with the air compressor to expel moisture from the air compressor.

15. The method according to claim 14, wherein collecting operating data associated with the air compressor during driving mode of the vehicle includes:
collecting temperature cycle running data associated with the air compressor during driving mode of the vehicle.

16. The method according to claim 14, wherein collecting operating data associated with the air compressor during driving mode of the vehicle includes:
collecting duty cycle running data associated with the air compressor during driving mode of the vehicle.

17. The method according to claim 14, wherein collecting operating data associated with the air compressor during driving mode of the vehicle includes:
collecting both temperature cycle running data and duty cycle running data associated with the air compressor during driving mode of the vehicle.

18. The method according to claim 17 further comprising:
not running the compressor in compressor conditioning mode based upon both a first criterion associated with the temperature cycle running data and a second criterion associated with the duty cycle running data being met, wherein (i) the first criterion comprises when the temperature cycle running data shows a temperature value that is greater than a predetermined minimum temperature value, and (ii) the second criterion comprises when the duty cycle running data shows a duty cycle percentage that is greater than a predetermined minimum percentage value.

19. The method according to claim 14, wherein controlling operation of the air compressor during compressor conditioning mode of the vehicle based upon collected operating data associated with the air compressor to expel moisture from the air compressor includes:
controlling operation of the air compressor during compressor conditioning mode of the vehicle based upon collected running data associated with the air compressor to vaporize water from compressor oil in the air compressor to allow the vaporized water to be directed away from the air compressor.

20. The method according to claim 19 further comprising:
directing the vaporized water through an exhaust port external to the air compressor to expel the water from the air compressor.

21. The method according to claim 14, wherein controlling operation of the air compressor during compressor conditioning mode of the vehicle based upon collected operating data associated with the air compressor to expel moisture from the air compressor includes:
controlling operation of the air compressor while the vehicle is parked during compressor conditioning mode of the vehicle based upon collected operating data associated with the air compressor to expel moisture from the air compressor.

22. The method according to claim 14, wherein the method is performed by a computer having a memory executing one or more programs of instructions which are tangibly embodied in a program storage medium readable by the computer.
